(19) United States
(12) Patent Application Publication
(10) Pub. No.: US 2004/0143073 A1
(43) Pub. Date: Jul. 22, 2004

(54) Method for determining gloss in polyester/beta-hydroxyalkylamide powder coatings

(76) Inventors: Imir Bejko, Cuneo (IT); Damiano Beccaria, Benevagienna (IT); Louis Thomas Germinario, Kingsport, TN (US); Penny J. Evans James, Northwich (GB); Gregory Alexander, Crystal Lake, IL (US); Andrea Capra, Fossano (IT)

Correspondence Address: Mark L. Davis, P.O. Box 9293, Gray, TN, 37615-9293, US

(21) Appl. No.: 10/751,052

(22) Filed: Jan. 2, 2004

Related U.S. Application Data
(60) Provisional application No. 60/440,204, filed on Jan. 15, 2003.

(51) Int. Cl. C08G 63/91

(52) U.S. Cl. 525/418

(57) ABSTRACT

A method for determining gloss in a curative powder coatings containing at least two polyester resins and β-Hydroxyalkylamide formulations. The method includes the steps of: providing a powder coating comprising a first polyester resin and β-hydroxyalkylamide formulation having a first acid value and a second polyester resin and β-hydroxyalkylamide formulation having a second acid value; blending the first and second formulations together to make coating; determining the percent difference in the acid values between the first and second polyester resins; determining a surface gloss of the coating after application; determining a gloss versus percent difference in acid values correlation; and determining the amount of at least one of the resins to be present in the blend to achieve the desired gloss using the correlation.

A multi-component powder coating having a substantially predetermined gloss when applied to a substrate. The coating includes at least two polyester resin and β-hydroxyalkylamide formulations blended together wherein each polyester resin has a different acid value. The amount of each formulation in the coating is determined in accordance with the above method to achieve the desired gloss.

### CROSS REFERENCE TO RELATED APPLICATIONS

Benefit is claimed to the earlier filed application having U.S. Ser. No. 60/440,204 filed Jan. 15, 2003 the entire disclosure of which is incorporated herein by reference.

### BACKGROUND OF THE INVENTION

1. Field of the Invention

The present invention relates to a method for predetermining gloss in powder coating formulations. More particularly, the present invention relates to a method for substantially determining gloss in polyester resins and β-hydroxyalkylamide curative powder coatings before applying the coating to the substrate. Another aspect of the present invention is a multi-component blend powder coating having a substantially predetermined gloss when applied to a substrate wherein the blend is formulated in accordance with the present method.

2. Background of the Invention

The powder coating business has enjoyed strong sustained growth since its inception as a major new coatings technology. The desirable performance of these coatings in combination with their environmental benefits have led to an increase in global powder coating production. Thermoset powder coating compositions can be applied to many different substrates, including metal substrates such as bare steel, phosphatized steel, galvanized steel, or aluminum; and non-metallic substrates, such as plastics and composites. The substrate may already have a layer of another coating, such as a layer of an electrodeposited primer, cured or uncured, applied before applying the powder coating composition. In a preferred embodiment, the substrate is an automotive body.

One powder coating, polyester-β-hydroxyalkylamide powder coatings have proven, after several years of use, to exhibit good overall performance, including exterior durability.

Formulators and original equipment manufacturers (OEM) divisionalize the powder coatings market based on different viewpoints. One important division centers on the degree to which a coating exhibits glossiness. Gloss is a measure of the percent of light reflected at a given angle from the coating's surface. Generally, segmentation based on gloss ranges are as follows:

| Segment | 60° Gloss Range |
|---|---|
| High Gloss | >80% |
| Medium Gloss | 30-80% |
| Low Gloss | 10-30% |
| Matte | <10% |

The demand by OEM designers for specific aesthetics has been instrumental in directing formulators to design and provide coatings with specific gloss values. Thus, there is a need for coatings suppliers to provide consistent powder coatings by controlling the gloss to within relatively narrow ranges.

High gloss coatings are, by definition, highly reflective. In theory, a perfectly smooth surface will reflect 100% of the light in the direction of the incident angle. A reduction in gloss occurs through a decrease in specular reflection and a corresponding increase in diffuse light scattering attributed to surface irregularities or imperfections. If surface irregularities are small in comparison to the incident wavelength a high gloss will be achieved; whereas surface imperfections or irregularities equal to or larger than the incident wavelength will cause light to be scattered diffusely upon reflection and thereby result in a lower brilliance and gloss value.

The very phenomenon that causes this unwanted gloss reduction is also the typical means by which formulators achieve the desired gloss in a powder coating. That is, coatings are intentionally formulated with differing degrees of incompatibility in order to achieve different effects on gloss.

One approach to achieve controlled gloss in TGIC-polyester systems has been to dry blend incompatible, formulated powder coatings. The desired degree of incompatibility is achieved by varying the resin reactivity. One method is to vary the reactivity by manipulating the difference in acid value between the two resins in the coatings, another is to adjust the catalyst level. The catalyst variation approach affords an easier way to achieve consistent and reproducible low gloss coatings. This is due to the ability to more precisely add small amounts of catalysts to a batch of polyester resin than it is to accurately to control the acid value and viscosity targets within tight tolerance levels. However, one problem with this method is that beta-hydroxyalkylamide-polyester cured systems cannot be catalyzed. Thus, there is a need for a method for producing beta-hydroxyalkylamide-polyester cured coatings with highly reproducible low gloss levels.

### SUMMARY OF THE INVENTION

Briefly, the present invention is a method for reproducibly substantially determining gloss for a polyester resins and β-Hydroxyalkylamide curative powder coating. To make the coating, at least two polyester resin and β-hydroxyalkylamide formulations of differing reactivities are blended together. The method includes the steps of providing a powder coating comprising a first polyester resin and β-hydroxyalkylamide formulation having a first acid value and a second polyester resin and β-hydroxyalkylamide formulation having a second acid value; blending the first and second formulations together to make coating; determining the percent difference in the acid values between the first and second polyester resins; determining a surface gloss of the coating after application; determining a gloss versus percent difference in acid values correlation; and determining the amount of at least one of the resins to be present in the blend to achieve the desired gloss using the correlation. The method of the present invention optionally includes adjusting the amount of at least one of the resins present in the blend to obtain the desired gloss.

In another aspect of the present invention, a multi-component powder coating having a substantially predetermined gloss when applied to a substrate. The coating includes at least two polyester resin and β-hydroxyalkylamide formulations blended together in accordance with the method of the present invention. In a preferred embodiment the powder coating is a binary resin blend containing a first polyester resin and a β-hydroxyalkylamide curative powder formulation and a second polyester resin and a β-hydroxyalkylamide curative powder formulation wherein the polyester resins have substantially predetermined acid values.

It is an object of the present invention to provide a method for formulating a multi-component polyester resin and the β-hydroxyalkylamide coating comprised of at least two polyester resin and the β-hydroxyalkylamide formulations to achieve a desired gloss. In a preferred embodiment, the coating is a dry-blend of two polyester resin and the β-hydroxyalkylamide formulations wherein the polyester resins have differing acid values.

Another object of the present invention is a powder coating having a substantially predetermined gloss. The coating includes at least two polyester resin and the β-hydroxyalkylamide formulations wherein each formulation includes a polyester resin having an acid number and the acid numbers of the polyesters are different.

This and other objects and advantages of the present invention will become more apparent to those skilled in the art in view of the following description. It is to be understood that the inventive concept is not to be considered limited to the constructions disclosed herein but instead by the scope of the appended claims.

### DETAILED DESCRIPTION OF THE INVENTION

One embodiment of the present invention is a method for reproducibly substantially determining the gloss in a multi-component curative powder coating. The coating includes at least at least two polyester resin and β-hydroxyalkylamide formulations of differing reactivities dry blended together. The acid value of each formulation is based on the polyester resin. Accordingly, the first polyester resin and β-hydroxyalkylamide formulation has a first acid value and the second polyester resin and β-hydroxyalkylamide formulation has a second acid value.

The polyester resin polymer usable in the formulations of the present invention have an average of two or more carboxyl groups. Such polyester resins are obtained by the condensation reaction between a polyol component and a poly-functional acid component. The equivalents of acid are in excess so an acid-functional polyester resin has an acid number of 10 to 300 mg KOH/gram, and preferably from 15 to 80 mg KOH/gram. The polyester desirably has a glass transition temperature (Tg) of 45 to 70° C. and the viscosity of the polyester, as measured at 200° C., is preferably from 1,000 to about 15,000 mPa.S.

The poly-functional acid component comprises compounds having two or more carboxyl groups or their anhydrides. Such compounds may be alkyl, alkylene, aralkylene, or aromatic compounds. Dicarboxylic acids and anhydrides are preferred. Acids or anhydrides with higher functionality may be used where some branching of the polyester is desired. When tri-functional or higher functionality compounds are used, it is possible to include mono-functional carboxylic acids or anhydrides or anhydrides of monocarboxylic acids, such as versatic acid, fatty acids, or neodecanoic acid, so long as the poly-functional acid component has an average functionality of at least two. Suitable polycarboxylic acid or anhydride compounds include, without limitation, those having from about 3 to about 20 carbon atoms. Illustrative examples of suitable compounds include, without limitation, phthalic acid, isophthalic acid, terephthalic acid, hexahydrophthalic acid, tetrachlorophthalic acid, trimellitic acid, pyromellitic acid, succinic acid, azeleic acid, adipic acid, citric acid, trimellitic acid, 1,4-cyclohexanedicarboxylic acid and anhydrides of these acids.

The polyol component used to make the polyester resin also has average functionality of at least two. The polyol component may contain mono-, di-, and tri-functional alcohols, as well as alcohols of higher functionality. Diols are the preferred polyols. Alcohols with higher functionality may be used where some branching of the polyester is desired, and mixtures of diols and triols are also preferred polyols. Examples of useful polyols are ethylene glycol, diethylene glycol, propylene glycol, dipropylene glycol, butylene glycol, glycerine, trimethylolpropane, trimethylolethane, pentaerythritol, neopentyl glycol, 2,2,4-trimethyl-1,3-pentanediol, 1,6-hexanediol, 1,4-cyclohexane dimethanol, hydrogenated bisphenol A, and hydroxyalkylated bisphenols.

Methods of making polyester resins are well known to those in the polymer art. Polyesters are typically formed by heating the polyol and poly-functional acid components together, with or without catalysis, while removing water by-product to drive the reaction to completion. Commercially available, polyesters resins suitable for preparing the formulations which in turn are used to make dry-blend powder coatings are sold by Eastman Chemical Company under the trade names of ALBESTER 5600 resin, ALBESTER 5540 resin, ALBESTER 5501 resin, ALBESTER 5550 resin, ALBESTER 5590 resin and ALBESTER 5580 resin. These carboxylated polyester resins have different acid values to facilitate use in different weight ratios with a curative powder coating.

The second component of the formulation composition is a β-hydroxyalkylamide resin or a polymer derived from a β-hydroxyalkylamide. Such resins are well known in the art and are described in greater detail in U.S. Pat. No. 4,076,917, the entire disclosure of which is incorporated herein by reference.

To cause curing, the β-hydroxyalkylamide, or polymer thereof, is mixed with the polyester at a ratio of from about 0.5 to about 2 parts of hydroxy functions per one part of carboxy or anhydride function. At 1:1 ratio of carboxy to hydroxy and a 0.5:1 ratio of anhydride to hydroxy function being preferred. Ratios outside of the above ranges may be employed but cross-linking efficiency is greatly reduced. For use with solution polymers, the cross-linking agent is dissolved directly into the polymer solution with or without a solvent. Depending on the solubility of the particular β-hydroxyalkylamide, solvents which may be employed include aromatics, such as toluene and xylene; aliphatics such as heptane and octane; water, dimethylformamide, dimethylsulfoxide, halogenated solvents, ethers, esters and alcohols,. Aqueous solutions are prepared from the salts of the carboxy polymers, for example amine salts such as dimethylaminoethanol, trimethylamine, triethylamine, diethanolamine, methylethanolamine, or ammonium salts.

In accordance with the method of the present invention, to make the coating the first and second formulations are blended together; preferably the formulations dry-blended. The formulations may be dry-blended using methods and techniques that are well known to those skilled in the blending art. For example, the materials may be blended using a Banbury mixer or other suitable mixing or blending apparatus that permits intimate mixing or blending of the components of the formulations. Desirably, the coating composition is a binary mixture of two polyester and β-hydroxyalkylamide formulations wherein the first and second formulations are blended at a ratio of from 1:20 to 20:1 parts by weight, preferably, from 1:10 to 10:1 parts by weight, more preferably from 1:5 to 5:1 parts by weight, and most preferably the first and second formulations are blended in a ratio of from 1:1 parts by weight. It is to be understood that the above ratios are for exemplary purposes only and the present invention further includes all values therebetween those specifically delineated.

The acid value of a particular formulation is determined by reference to the polyester resin alone. Methods by which the acid value of a polyester is determined are routine to those skilled in the polyester art. For example, acid values of the resins specified herein were determined in accordance with ASTM method D-1639.

The percent difference (Δ %) in values of the resins is determined by equation I:

(Δ %)=100×(absolute (value1−value2))/(average of the values). I

The method of the present invention further includes substantially determining the surface gloss of the coating utilizing the at least two polyester resin and β-hydroxyalkylamide formulations having different acid numbers at a predetermined weight ratio after being applied to a substrate and subjected to a predetermined curing temperature for a predetermined amount of time. As used herein, the term “substantially” means that the error in the calculated value for the gloss and the actual value will be less than 10%, preferably less than 5%, and more preferably less than 3%. For example, the coating surface gloss may be determined for a binary blend of polyester resin and β-hydroxyalkylamide formulations at a weight ratio of 1:1 wherein the polyester resin in each formulation has a different acid number. The coating formulation thereafter being applied to a substrate and subjected to a temperature of from 125° to 250° C. for a period of time ranging from about 0.5 to about 30 minutes. Optionally, the coating gloss correlation is determined utilizing at least two polyester resin and β-hydroxyalkylamide formulations at various weight ratios of each formulation.

Utilizing the values of the percent difference in acid values and the surface gloss of the coating comprising at least two polyester resin and β-hydroxyalkylamide formulations, a best fit correlation equation is determined for gloss versus percent difference in acid values data. Desirably, the correlation equation is a linear equation of formula II:

Gloss at the specified temperature=mx+b; II

wherein “m” is the slope, “x” is the Δ % as defined herein, and “b” is the intercept.

Accordingly, utilizing the above correlation for the surface gloss and Δ % in acid values, a coating having a substantially predetermined gloss can be formulated using at least two polyester resin and β-hydroxyalkylamide formulations wherein each polyester resin has a different acid value. Optionally, the method provides a surface coating having a substantially predetermined gloss using at least two polyester resin and β-hydroxyalkylamide formulations wherein, based on the weight ratio of the two polyester resins, the amount of at least one polyester resin present in the blend is determined.

Processing and performance additives are optionally incorporated into the coating composition. These include fillers, pigments, leveling agents to help coalesce the coating film, plasticizers, flow control agents to smooth the film, air release agents, hindered amine light stabilizers, ultraviolet light absorbers, antioxidants, and catalysts. Particularly recommended for powder coatings are degassing agents which allow volatiles to escape from the film during baking and flow control agents to prevent fish-eye. Benzoin is a preferred degassing agent.

Pigments may also be used in amounts up to 35% by weight, based on total weight of the coating composition. The pigments may include metal oxides, chromates, molybdates, phosphates, and silicates, titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, talc, barytes, ferric ammonium ferrocyanide (Prussian blue), ultramarine, lead chromate, lead molybdate, and mica flake pigments. Organic pigments include metallized azo reds, quinacridone reds and violets, perylene reds, copper phthalocyanaine blues and greens, carbazole violet, monoarylide and diarylide yellows, benzimidazolone yellows, tolyl orange, naphthol orange, and the like.

Flow control agents prevent formation of dirt craters by reducing surface tension. Dirt cratering is caused by dirt falling on the coating before it is cured. Flow control agents are generally nonfunctional, low Tg polymers, such as acrylic or siloxane polymers or fluorinated polyesters. Examples include polylauryl acrylate, polybutyl acrylate, poly(2-ethylhexyl) acrylate, polylauryl methacrylate, poly(dimethylsiloxane), and esters of polyethylene glycol or polypropylene glycol and fluorinated fatty acids.

Flow control agents are used in very low amounts. When the amount exceeds about 2% the coating tends to degrade in appearance and other properties. A primer coating using more than about 2% of flow control agent exhibits poor intercoat adhesion to a topcoat applied subsequently in the coating process.

Hindered amine light stabilizers, ultraviolet light absorbers, and antioxidants may be added in ways and amounts known to the art to improve the durability of the finished coating, particularly for outdoor applications.

The particulate ingredients may be added separate, together or sequentially, or the particulate ingredients may be dry mixed and added together as a mixture. The powered ingredients may be dry mixed using a suitable mixer, for example a Henchel mixer. The powdered ingredients include at least one polyester resin and β-hydroxyalkylamide resin. Other materials, such as pigments or filler materials, described in greater detail herein, may also be added.

Another embodiment of the present invention is a multi-component powder coating having a substantially predetermined gloss when applied to a substrate. The coating includes at least two polyester resin and β-hydroxyalkylamide formulations blended together wherein each polyester resin has a different acid number. In a preferred embodiment the powder coating is a binary resin blend containing a first polyester resin and a β-hydroxyalkylamide curative powder formulation and a second polyester resin and a β-hydroxyalkylamide curative powder formulation. The polyester resin formulations can be prepared by first melt blending the ingredients. This usually involves dry blending in a planetary mixer and then melt blending the admixture in an extruder at elevated temperature. The extrusion temperature is high enough to allow the resin to melt to a viscosity that produces good mixing and pigment wetting, Such melt blending is usually carried out from 60° C. to 130° C.

The melt blended extrudate is then cooled and pulverized. The extrudate may be crushed to a fine flake or granule and then ground and classified by sieving or other means. The maximum particle size and the particle size distribution are controlled in the classifying step and affect the smoothness of the final powder coating film. Requirements for these para meters depend upon the particular use and application method.

Application of the powder coating can be by electrostatic spraying or by use of a fluidized bed. Electrostatic spraying is the preferred method. The coating powder can be applied in one or more passes to provide a coating film thickness after cure of from 25 to 400 microns and preferably, the coating thickness is from 50 to about 250 microns. The substrate can optionally be preheated before applying the powder coating composition to promote uniform and thicker powder deposition.

The polyester polymer/β-hydroxyalkylamide (β-HAA) powder coating is cured by heating the coating at a temperature of from 125° to about 400° C., desirably the coating is heated at a temperature of from 125° to 250° C., and more desirably in the range of from 180° to 200° C., for a period of time ranging from about 0.5 to about 30 minutes. Although it is possible to employ a catalyst to effect curing, a catalyst is not necessary.

### EXAMPLES

A number of black and white blended binary coatings were prepared from individual formulations utilizing polyester resins having different acid numbers using the following polyester resins:

ALBESTER 5600—Resin 1;

ALBESTER 5540—Resin 2;

ALBESTER 5501—Resin 3;

ALBESTER 5550—Resin 4;

ALBESTER 5590—Resin 5; and

ALBESTER 5580—Resin 6.

Polyester Resins 1-6 employed have a range of both acid values and gel times as shown in Table II below.

TABLE II

| | AV | Viscosity 200° C. | Tg | Gel Time 180° C. |
|---|---|---|---|---|
| | (mg KOH) | (mPa · s) | (° C.) | (Minutes) |
| Resin 1 | 16 | 6300 | 50 | 6.50 |
| Resin 2 | 20 | 6000 | 60 | 4.25 |
| Resin 3 | 25 | 5100 | 59 | 3.25 |
| Resin 4 | 35 | 3400 | 60 | 2.33 |
| Resin 5 | 49 | 3800 | 67 | 1.50 |
| Resin 6 | 73 | 2400 | 54 | 2.00 |

Individual polyester resins/β-HAA formulations were prepared by pre-grinding the polyester resins, β-HAA, and additives all together. The formulations were classified using a 106μ sieve. Unless specified otherwise, each surface coating contains two polyester resins/β-HAA formulations wherein the polyester of each formulation has a different acid number. The surface coating was prepared by dry-blending the individual formulations at a 1:1 weight % ratio in the combinations described below. The surface coating was sprayed on smooth finish, untreated, bare steel panels measuring 0.5 millimeters (mm)×76 mm×152 mm, available from Q-Panel Lab Products (QD-36 panels) using 60 KV corona spray. Each coating was cured at two different baking temperatures and times. The following ASTM test methods were used to evaluate the coatings:

Method D 523 for testing gloss using the Byk Gardner “Micro-Tri-Gloss”; and

Method D 2794 for testing direct and reverse impacts.

White coating formulations, in grams, were prepared as shown in Table III below.

TABLE III

| | Formulation | | | | | |
|---|---|---|---|---|---|---|
| Components | F1 | F2 | F3 | F4 | F5 | F6 |
| Polyester | Resin 1 | Resin 2 | Resin 3 | Resin 4 | Resin 5 | Resin 6 |
| | 605.7 | 602.6 | 599.5 | 590.2 | 575.6 | 559.2 |
| β-HAA | 15.5 | 18.6 | 21.7 | 31 | 43.2 | 62 |
| Flow Agent | 6.8 | 6.8 | 6.8 | 6.8 | 6.8 | 6.8 |
| Benzoin | 2 | 2 | 2 | 2 | 2 | 2 |
| TiO2 | 370 | 370 | 370 | 370 | 370 | 370 |
| Total | 1000 | 1000 | 1000 | 1000 | 1000 | 1000 |
| Pigment:Binder | 38:62 | 38:62 | 38:62 | 38:62 | 38:62 | 38:62 |
| Polyester:β-HAA | 97.5:2.5 | 97:3 | 96.5:3.5 | 95:5 | 93:7 | 90:10 |

β-HAA is sold under the trade name PRIMID XL 552 available from EMS-Primid, Flow Agent is sold under the trade name RESIFLOW PV 88 produced by Worlee Benzoin is sold under the trade name BENZOIN commercialized by Merck. TiO2 is sold under the trade name KRONOS 2160 produced by Kronos. Wax is sold under the trade name LANCOWAX 1362 D produced by Lubrizol. Carbon Black is sold under the trade name FW 200 produced by Deguss BaSO4 is sold under the trade name BARITINA 30 micron produced by Mineral Giruna.

Test results for the white formulations are shown in Table IV below.

TABLE IV

| | Cure conditions | Gloss | Direct | Reverse | % β-HAA |
|---|---|---|---|---|---|
| Coating | (min. at ° C.) | 60° | Impact | Impact | in blend |
| 1 | 15 × 180° C. | 28 | 40 | 20 | 6.75 |
| (F3 + F6) | 10 × 200° C. | 25 | 60 | 30 | |
| 2 | 15 × 180° C. | 23 | 30 | 20 | 6.5 |
| (F2 + F6) | 10 × 200° C. | 20 | 40 | 20 | |
| 3 | 10 × 180° C. | 75 | 160 | 160 | 6.0 |
| (F5 + F4) | 10 × 200° C. | 73 | 160 | 160 | |
| 4 | 15 × 180° C. | 36 | 100 | 100 | 5 |
| (F2 + F5) | 10 × 200° C. | 34 | 120 | 120 | |
| 5 | 15 × 180° C. | 45 | 160 | 160 | 5.25 |
| (F3 + F5) | 10 × 200° C. | 42 | 160 | 160 | |
| 6 | 20 × 180° C. | 27 | 160 | 140 | 4.75 |
| (F1 + F5) | 10 × 200° C. | 25 | 160 | 140 | |
| 7 | 20 × 180° C. | 56 | 160 | 140 | 4 |
| (F2 + F4) | 10 × 200° C. | 60 | 160 | 160 | |
| 8 | 10 × 180° C. | 41 | 160 | 160 | 3.75 |
| (F1 + F4) | 10 × 200° C. | 38 | 160 | 160 | |
| 9 | 20 × 180° C. | 68 | 120 | 100 | 2.75 |
| (F1 + F2) | 10 × 200° C. | 66 | 140 | 120 | |

Black coating formulations were prepared as shown in Table V below.

TABLE V

| | Formulation | | | | | |
|---|---|---|---|---|---|---|
| Components | F7 | F8 | F9 | F10 | F11 | F12 |
| Polyester | Resin 1 | Resin 2 | Resin 3 | Resin 4 | Resin 5 | Resin 6 |
| | 644.5 | 641 | 638 | 630 | 615 | 595 |
| (β-HAA) | 16.5 | 20 | 23 | 33 | 46 | 66 |
| Flow Agent | 16 | 16 | 16 | 16 | 16 | 16 |
| Benzoin | 2 | 2 | 2 | 2 | 2 | 2 |
| Wax | 20 | 20 | 20 | 20 | 20 | 20 |
| Carbon black | 8 | 8 | 8 | 8 | 8 | 8 |
| BaSO₄ | 293 | 293 | 293 | 293 | 293 | 293 |
| Total | 1000 | 1000 | 1000 | 1000 | 1000 | 1000 |
| Pigment:Binder | 34:66 | 34:66 | 34:66 | 34:66 | 34:66 | 34:66 |
| Polyester:Crosslinker | 97.5:2.5 | 97:3 | 96.5:3.5 | 95:5 | 93:7 | 90:10 |

Test results for the black formulations are shown in Table VI below.

TABLE VI

| | Cure conditions | Gloss | Direct | Reverse | % β-HAA |
|---|---|---|---|---|---|
| Coating | (min. at ° C.) | 60° | Impact | Impact | in blend |
| 10 | 20 × 180° C. | 15 | 100 | 100 | 6.75 |
| (F9 + F12) | 10 × 200° C. | 14 | 120 | 120 | |
| 11 | 20 × 180° C. | 13 | 60 | 30 | 6.5 |
| (F8 + F12) | 10 × 200° C. | 12 | 80 | 40 | |
| 12 | 10 × 180° C. | 47 | 160 | 160 | 6.0 |
| (Fl1 + F10) | 10 × 200° C. | 42 | 160 | 160 | |
| 13 | 15 × 180° C. | 26 | 120 | 120 | 5.25 |
| (F9 + F11) | 10 × 200° C. | 25 | 160 | 160 | |
| 14 | 15 × 180° C. | 21 | 120 | 120 | 5 |
| (F8 + F11) | 10 × 200° C. | 20 | 140 | 140 | |
| 15 | 20 × 180° C. | 16 | 160 | 160 | 4.75 |
| (F7 + F11) | 10 × 200° C. | 14 | 160 | 160 | |
| 16 | 20 × 180° C. | 37 | 160 | 160 | 4 |
| (F8 + F10) | 10 × 200° C. | 33 | 160 | 160 | |
| 17 | 20 × 180° C. | 25 | 160 | 160 | 3.75 |
| (F7 + F10) | 10 × 200° C. | 22 | 160 | 160 | |
| 18 | 20 × 180° C. | 49 | 160 | 160 | 2.75 |
| (F7 + F8) | 10 × 200° C. | 47 | 160 | 160 | |

Table VII below summarizes the relationships between coating performance, gloss and impact resistance, and differences in resin properties used in the dry blends. In this table, impact resistance is classified as poor (−), good (o) and excellent (+).

TABLE VII

| | Acid | | | White Gloss | | Black Gloss | |
|---|---|---|---|---|---|---|---|
| | Value | Gel | Viscosity | & Impact | | & Impact | |
| | mg KOH | time | mPa · s | High | Low | High | Low |
| Coating | Δ % | Δ % | Δ % | Temp | Temp | Temp | Temp |
| 1 (white) | 106% | 55% | 73% | 25 | 28 | 14 | 15 |
| 10 (black) | | | | − | − | o | o |
| 2 (white) | 132% | 84% | 87% | 20 | 23 | 12 | 13 |
| 11 (black) | | | | − | − | − | − |
| 3 (white) | 36% | 43% | 11% | 73 | 75 | 42 | 47 |
| 12 (black) | | | | + | + | + | + |
| 4 (white) | 91% | 97% | 48% | 34 | 36 | 20 | 21 |
| 13 (black) | | | | o | o | o | o |
| 5 (white) | 67% | 74% | 32% | 42 | 45 | 25 | 26 |
| 14 (black) | | | | + | + | + | o |
| 6 (white) | 115% | 140% | 51% | 25 | 27 | 14 | 16 |
| 15 (black) | | | | + | o | + | + |
| 7 (white) | 53% | 59% | 54% | 60 | 56 | 33 | 37 |
| 16 (black) | | | | + | + | + | + |
| 8 (white) | 76% | 102% | 56% | 38 | 41 | 22 | 25 |
| 17 (black) | | | | + | + | + | + |
| 9 (white) | 22% | 42% | 5% | 68 | 60 | 47 | 49 |
| 18 (black) | | | | o | o | + | + |

In studying gloss in various coatings containing polyester resins and β-hydroxyalkylamide, using both black and white coatings, it was determined the following formulas describe the relationships between gloss and % delta acid value:

White Gloss (200° C.)=83−0.5 (Δ %), R²=0.93. III

White Gloss (180° C.)=78−0.4 (Δ %), R²=0.88. IV

Black Gloss (200° C.)=51−0.3 (Δ %), R²=0.94. V

Black Gloss (180° C.)=55−0.4 (Δ %) R²=0.93. VI

### Comparative Example 1

The viscosity difference of resins is considered to be an important variable for achieving gloss control because, for a given temperature during cure, coatings that are based on resins with different viscosities will flow and level at different rates. Intimate mixing of the individual resins in coatings will decrease, with an increase in magnitude of the difference in their respective viscosities. The resulting difference in leveling and flow of the respective polymer domains could lead to lower gloss, due to increased levels of surface roughness and surface imperfections.

It was determined that using the viscosity difference of resins was not an acceptable predictor of the resulting gloss a coating would have with an absolute statistical correlation of less than 0.9.

### Comparative Example 2

Gel-time is an empirical measure of a resin's reactivity. A test was performed by first physically blending the polyester resins and the curing agent in a stoichiometric ratio. The mixture was then positioned on a hot-plate and kept at a specific temperature and the time required to reach the gel point of the mixture, is measured.

It was determined that using gel-time difference of resins was not an acceptable predictor of the resulting gloss a coating would have with an absolute statistical correlation of less than 0.5.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

We claim:

1. A method for substantially predetermining gloss in a polyester resin and β-hydroxyalkylamide curative powder coating containing at least two polyester resins, said method comprising:
a). providing a first formulation comprising a first polyester resin and β-hydroxyalkylamide resin;
b) providing a second formulation comprising a second polyester resin and β-hydroxyalkylamide resin, wherein said first and second polyester resins have different acid values;
c) blending said first and second formulations together to make coating;
d) determining a surface gloss of the coating after application;
e) determining a gloss versus a percent difference in acid values correlation; and
f) determining an amount of at least one of said resins to be present in said coating to achieve the desired gloss using said correlation.

2. The method of claim 1 further comprising determining the percent difference in the acid values between the first and second polyester resins before performing step (c).

3. The method of claim 1 wherein said polyester resin includes at least two carboxyl groups.

4. The method of claim 3 wherein said polyester resin has an acid number of 10 to 300 mg KOH/gram.

5. The method of claim 3 wherein said polyester resin has an acid number of from 15 to 80 mg KOH/gram.

6. The method of claim 1 wherein said polyester resin has a viscosity, as measured at 200° C., of from 1000 to about 15000 mPa.s.

7. The method of claim 1 wherein said β-hydroxyalkylamide is mixed with said polyester at a ratio of from about 0.5 to about 2 parts of hydroxy functions per one part of carboxy or anhydride function.

8. The method of claim 1 wherein said first and second formulations are blended in a ratio of from 1:20 to 20:1 parts by weight.

9. The method of claim 1 wherein said first and second formulations are blended in a ratio of from 1 :10 to 10:1 parts by weight.

10. The method of claim 1 wherein said first and second formulations are blended in a ratio of from 1:5 to 5:1 parts by weight.

11. The method of claim 1 wherein said first and second formulations are blended in a ratio of 1:1 parts by weight.

12. The method of claim 1 wherein said gloss versus a percent difference in acid values correlation is determined using multiple polyester resin and β-hydroxyalkylamide resin formulations at fixed parts by weight ratio.

13. The method of claim 1 wherein said gloss versus a percent difference in acid values correlation is determined using two polyester resin and β-hydroxyalkylamide resin formulations at varied parts by weight ratios.

14. The method of claim 1 wherein said gloss versus a percent difference in acid values correlation is determined using multiple polyester resin and β-hydroxyalkylamide resin formulations at varied parts by weight ratios.

15. A multi-component powder coating comprising a blend of:
a) a first formulation comprising a first polyester resin and β-hydroxyalkylamide resin; and
b) a second formulation comprising a second polyester resin and β-hydroxyalkylamide resin, wherein said first and second polyester resins have different acid values.

16. The coating of claim 15 wherein said polyester resin includes at least two carboxyl groups.

17. The coating of claim 15 wherein said polyester resin has an acid number of 10 to 300 mg KOH/gram.

18. A multi-component powder coating having a substantially predetermined gloss comprising:
a) a first formulation comprising a first polyester resin and β-hydroxyalkylamide resin; and
b) a second formulation comprising a second polyester resin and β-hydroxyalkylamide resin, wherein said first and second polyester resins have different acid values,
wherein said coating is prepared by:
i) blending said first and second formulations together to make coating;
ii) determining a surface gloss of the coating after application;
iii) determining a gloss versus a percent difference in acid values correlation;
iv) determining an amount of at least one of said resins to be present in said coating to achieve the desired gloss using said correlation; and
v) determining an amount of at least one of said resins to be present in the coating to achieve the desired gloss.

19. The multi-component dry powder coating of claim 12 wherein said first and second formulations are blended in a ratio of from 1:20 to 20:1 parts by weight.

20. The multi-component dry powder coating of claim 12 wherein said first and second formulations are blended in a ratio of from 1:1 parts by weight.
